(19) United States
(12) Patent Application Publication
(10) Pub. No.: US 2011/0097253 A1
(43) Pub. Date: Apr. 28, 2011

(54) FLUORINE PURIFICATION

(75) Inventors: Yuichi Iikubo, West Lafayette, IN (US); Stephen Owens, Wartrace, TN (US)

(73) Assignee: FLUOROMER LLC, West Lafayette, IN (US)

(21) Appl. No.: 12/606,667

(22) Filed: Oct. 27, 2009

(51) Int. Cl. C01B 21/06; B01D 53/00; B03C 3/01

(52) U.S. Cl. 423/235; 95/288; 95/73

(57) ABSTRACT

A method producing a volume of purified F₂ comprising removing HF from a F₂ feed and removing CF₄ from the F₂ feed, wherein a concentration of HF in the volume of purified F₂ is less than 1 ppm (v/v) and a concentration CF₄ in the volume of purified F₂ is less than 10 ppm (v/v).

### FIELD OF THE INVENTION

The present disclosure relates to the field of ultra-pure gases. More specifically, the disclosure relates to apparatuses and methods for the production of ultra-pure fluorine and ultra-pure nitrogen trifluoride.

### BACKGROUND AND PRIOR ART

Elemental fluorine (F₂) is extremely reactive combining easily with most organic and inorganic materials. Historically, the largest use of F₂ was in the manufacture of uranium hexafluoride for use in the nuclear power industry. Other uses included the production of SF₆ for use in electrical and electronic equipment and the production of selective fluorinating agents. Newer uses for F₂ include laser applications and as a reactant in semiconductor manufacturing.

F₂ is primarily produced by the electrolysis of KF.HF with an anode oxidizing fluoride ions to liberate F₂ and a cathode reducing hydrogen ions to liberate H₂. Generally, the anode is carbon and the cathode is nickel. The electrolytic process requires a significant overvoltage for the production of As the F₂ can react with the carbon electrode to produce a fluorinated carbon layer that has low electrical conductivity and is not wetted by the molten KF.HF solution, F₂ bubbles can cling to the carbon anode surface. High localized F₂ concentrations on the carbon anode surface and localized hot spots created by increasing current discharge densities contribute to a burning of the carbon electrode and production of CF₄ as a contaminant in the F₂ product stream.

One growing use of fluorine is the cleaning of unwanted deposits from semiconductor deposition chambers. The build up of impurities on the walls of semiconductor deposition chambers increases the risk of contamination of the manufactured product. These deposits can be easily removed with a fluorine plasma, that can for example remove unwanted silicon-containing oxide deposits from the interior chamber walls. The generation of the fluorine plasma is more safely obtained with fluorine-containing compounds such as, for example, NF₃, CF₄, C₂F₆, or SF₆ than with elemental F₂. In essence, any fluorine-containing gas that can be decomposed into active fluorine species potentially can be used for chamber cleaning.

As sulfur and carbon contamination of the deposition chamber from plasmas produced from CF₄, C₂F₆, or SF₆ can cross-contaminate manufactured materials, NF₃ is a preferable fluorine plasma precursor. U.S. Pat. No. 7,413,722, incorporated herein by reference in its entirety, describes the production of NF₃ by the reaction of NH₃ and F₂ in the presence of NH₄F. As the development of the electronics industry has progressed, higher purity NF₃ has been required.

Present-day electronic industry sets very high requirements for the purity of nitrogen trifluoride used in technologies of high-purity semiconductor materials. Often, supplies of NF₃ need to be at least 99.9-99.999% NF₃. The most difficult technological task is purifying NF₃ that contains a CF₄ impurity, since even small amounts of CF₄ create a significant problem in the process of etching semiconductors due to the formation of carbon or silicon carbide residues. The difficulty of separating NF₃ and CF₄ stems from an insignificant difference in the size of the molecules and in their boiling points—the difference in boiling points does not exceed 1° C.

Known in the art is a process of separating gaseous fluorides by gas chromatography techniques, using as the separation phase a silica gel having an average pore diameter of 22 Å mixed with a liquid low-molecular weight chlorotrifluoroethylene polymer in an amount of 5-30 wt. % (see for example U.S. Pat. No. 3,125,425). The polymer is liquid at 0° C., has a molecular weight of 200 to 1500 and a boiling point of 121-260° C. at 0.5 mm of Hg pressure. The process of gas chromatography separation enables obtaining gaseous fluorides with a concentration higher than 90 wt. % from gas mixtures containing NF₃ and CF₄, at temperatures of −80 to 50° C. However, this process suffers from significant disadvantages such as low efficiency, high consumption of inert gas, and insufficient separation. Moreover, the purity of the NF₃ obtained by the process does not exceed 99 vol. %.

Nowhere in the prior art has anyone described an inexpensive, efficient, and continuous method for the production or purification of NF₃ for the electronics industry. The need for ultrapure NF₃ having a NF₃ concentration of at least 99 vol. %, preferably at least 99.5 vol. %, and more preferably in the range of 99.9 vol. % to 99.999 vol. % will continue to grow as the demands in the electronics industry for more precise manufacturing increase.

The present invention circumvents the problems and inefficiencies of the prior art by providing F₂ and/or NF₃, each being essentially free (containing 0.1, preferably 0.0) and more preferably 0.001 vol. % or less) of KF, HF, and/or CF₄ contaminants. The apparatus and methods described herein provide for the continuous or batch process generation of ultrapure F₂ and ultrapure NF₃.

### SUMMARY

The present invention provides apparatus and methods for purifying, or manufacturing ultra pure elemental fluorine and/or NF₃. In particular the present invention provides apparatus and methods for separating CF₄ from F₂. Moreover, the present invention solves the problem of HF and KF dust contamination of gas feed and feed lines.

One aspect of the present disclosure is the separation of KF dust from an F₂ product stream. The KF dust is removed through dissolution in HF and the resulting F₂ product stream is essentially free of KF.

Another aspect of the present disclosure is the separation of HF from an F₂ product stream. The HF concentration in the F₂ product stream can be lowered to less than 0.5 ppm (v/v), preferably less than 0.1 ppm (v/v).

Yet another aspect of the present disclosure is the separation of CF₄ from an F₂ product stream. The CF₄ concentration in the F₂ product stream can be lowered to less than 10 ppm (v/v), preferably less than 4 ppm (v/v).

Still another aspect of the present disclosure is the continuous operation of an F₂ purification apparatus. Continuous operation is preferable for the industrial production and use of F₂ because the continuous operation reduces contamination to the apparatus and to the product stream. Continuous operation, additionally, reduces wasted product, time, and expense associated with shutting down and starting up the purification process

Still another aspect of the present disclosure is the precise control of separation temperatures through the use of refluxing liquids. The refluxing of liquids reduces the need for control units to closely monitor, e.g., cool or heat a product/contaminant separation process stream, since in order to maintain an effective separation temperature of a purification process system, all that is required is a secondary coolant that condenses a boiling liquid that may be either the product or a contaminant liquid.

### BRIEF DESCRIPTION OF THE DRAWINGS

FIG. 1 is a schematic representation of an F₂ purification apparatus 100 coupled to an NF₃ reactor 111.

FIG. 2 is a cross-sectional view of an HF Separation Unit 200 showing an HF Separation Chamber 220 and Coolant Chamber 202;

FIG. 3 is a cross-sectional view of an HF Separation Unit 300 similar to that shown in FIG. 2, showing gas flow paths therethrough;

FIG. 4 is a cross-sectional view of another embodiment of an HF Separation Unit 400 showing a design of the unit having a HF Separation Chamber 420 and a Coolant Condensation Unit 480. The drawing additionally schematically shows control elements for the regulation of temperature and the regulation of an F₂ product stream 401;

FIG. 5 is a cross-sectional view of an embodiment of a Low Temperature HF Separation Unit 500 showing an HF Separation Chamber 520 and a Coolant Chamber 541;

FIG. 6 is a cross-sectional view of one embodiment of a CF₄ Separation Unit 600 showing a CF₄ Separation Chamber 620 and a Coolant Chamber 603;

FIG. 7 is a cross-sectional view of another embodiment of a CF₄ Separation Unit 700 showing a CF₄ Separation Chamber 740 and a Coolant Chamber 703;

FIG. 8 is a cross-sectional view of another embodiment of a CF₄ Separation Unit 800 showing a CF₄ Separation Chamber 820, and a Coolant Chamber 803, and an F₂ reboiler 880. Also shown schematically, are control elements for the regulation of temperature and the regulation of the F₂ product stream 801;

FIG. 9 is a schematic representation of an F₂ purification apparatus including a F₂ generator 901 as a F₂ source, a Low Pressure HF Separation Unit 950, an F₂ Compressor 903, a High Pressure HF Separation Unit 960, a plurality of Low Temperature HF Separation Units 970, and a CF₄ Separation Unit 980; and

FIG. 10 is a cross-sectional view of another embodiment of an HF Separation Unit 1000 showing electrostatic separation units. The drawing additionally schematically shows control elements for the regulation and temperature, pressure, the F₂ product stream 1001, and voltage.

### DETAILED DESCRIPTION OF THE PREFERRED EMBODIMENTS

Herein, ranges may be expressed as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Additionally, compilations of parts of or areas in devices are at times designated specific regions, these regions are described based on the theorized primary event occurring in the designated region. Regions can and often overlap and other events can and likely occur within the specifically designated regions.

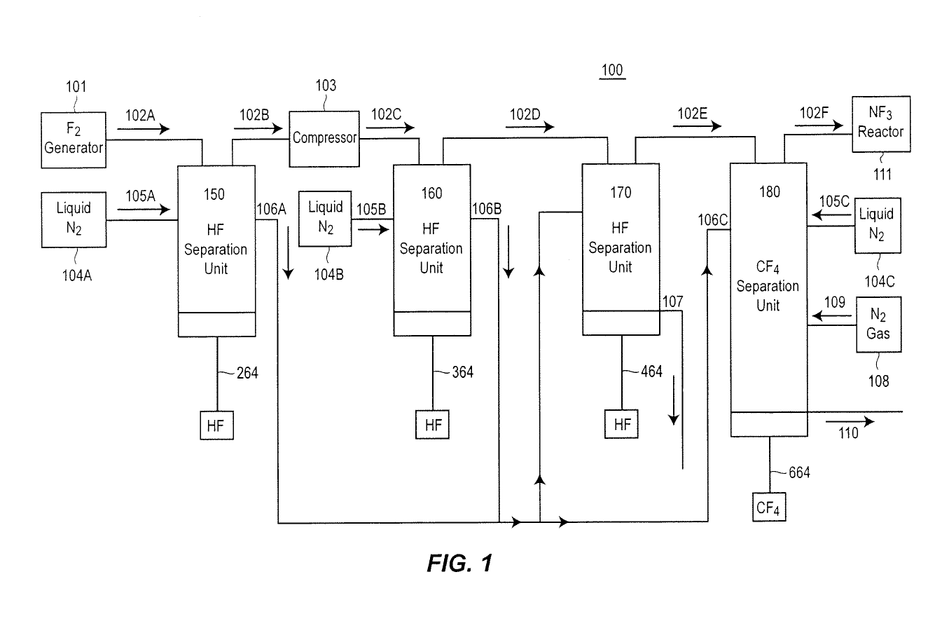

The F₂ purification process and apparatus as shown in FIG. 1 includes an F₂ generator 101 as an F₂ source, a plurality of HF Separation Units 150, 160, & 170, a CF₄ Separation Unit 180, and a NF₃ reactor 111. FIG. 1 shows the flow paths 102A-F for the F₂ product stream from the F₂ Generator 101 to the NF₃ Reactor 111, the flow paths 105A-C for N₂ coolant into the separation units 150, 160, & 180, the flow paths 106A, and 106B for the recycled/reused N₂ coolant into the HF Separation Unit 170, and the flow path 106C for the N₂ gas into the CF₄ Separation Unit 180 as a heat source for reboiling condensed CF₄.

Additional features of the Fluorine Purification Apparatus 100 can be useful for the efficient operation of the apparatus. As described in more detail hereinafter, these features include precise temperature control via the addition and removal of coolant, e.g., liquid N₂ to and from the HF and CF₄ separation units 150, 160, 170 and 180 through Coolant Conduits 105A, 105B, 105C, 106A, 106B, 106C, 107, 109, and 110.

The Fluorine Purification Apparatus 100 can optionally include multiple HF and CF₄ separation units that may include Low Pressure HF Separation Units, High Pressure HF Separation Units, Low Temperature HF Separation Units, Electrostatic HF Separation Units, and/or CF₄ Separation Units; all described in further detail below. The final number and arrangement of the Separation Units is dependant on the needed purity of F₂ product and desired flow rate.

The purification of F₂ as described herein, is effectuated by the removal of KF dust, HF, and CF₄ from an F₂ product stream produced by an F₂ generator. As described above, the production of F₂ may include the electrolysis of a KF.HF molten salt solution. This electrolysis produces primarily F₂ but the F₂ gas flowing from the electrolytic baths may also contains KF, HF, and/or CF₄ impurities. An important aspect of the methods and apparatus described herein is the removal of these impurities, particularly CF₄, prior to using the purified F₂ to manufacture NF₃. Another important aspect of the methods and apparatus described herein is the removal of these impurities in a purification apparatus and method. Yet another important aspect is the purification of F₂ in an apparatus and method while reducing the likelihood of F₂ reactions, achieved at least in part due to the processing apparatus having a minimum internal surface area.

In accordance with one aspect of the methods and apparatus described herein, the KF and HF impurities are removed from an F₂ product stream prior to the removal of CF₄ from the F₂ product stream. As a solid material, KF can be removed from the F₂ product stream via filtration but any filter would significantly increase the internal surface area of the purification apparatus, thereby increasing the potential for side reactions within the apparatus. Herein, a first apparatus and method for the removal of both KF and HF from the product stream is called an HF Separation Unit, for reasons that will become clear.

Some of the apparatus, or portions thereof, described herein are called Condensation Regions, Separation Chambers, Separation Regions, Evaporation Regions, and Separation Units. Broadly, these terms refer to the physical changes to the gas and/or liquid and solid compositions occurring in the apparatus. The Separation Units are generally a part of the apparatus wherein a specific chemical or mixture of chemicals are separated from the F₂ product stream. Within the Separation Units are Separation Chambers, wherein the F₂ product stream is separated into specific chemicals or mixtures; the Separation Chambers can encompass the entire Separation Unit or the Separation Unit can include additional features. Condensation Regions are the general areas within the Separation Chambers wherein portions of the gaseous product stream are condensed; the Condensation Regions are generally in fluid communication with a beat exchanger that provides a means for lowering the temperature of the gaseous product stream and condensing a chemical or mixture. Separation Regions are the general areas within the Separation Chambers wherein the condensed (liquid) product and the gaseous product stream are physically diverted. The Separation Regions can overlap with the Condensation Regions or the two regions can be separate. Evaporation Regions are the general areas within the Separation Unit wherein condensed (liquid or solid) product is converted to a gaseous product; the conversion process can be by warming, applying a vacuum, or a combination thereof.

### Removal of KF and HF from the F₂ Gas

One embodiment of the purification of an F₂ product, as described herein, includes the removal of KF and HF from the F₂ product stream (a purified F₂ gas). Typically, the F₂ product stream is a purified F₂ gas (product) produced by an electrolytic F₂ generator. Herein, the removal of HF and/or KF is effectuated by one or more HF separation units. The HF separation units, described herein, operate by condensing (liquid) and/or precipitating (solid) HF from the F₂ product stream and separating the liquid and/or solid HF from the F₂. Multiple embodiments of HF separation units are disclosed herein, for example a Low Pressure HF separation unit, a High Pressure HF separation unit, a Low Temperature HF separation unit, and an Electrostatic HF separation unit. All of these embodiments result in the physical separation of HF liquid and/or solid from the purified F₂ gas product stream, as will be described in more detail to follow. In the preferred embodiment, HF is separated from the gas mixture prior to separation of CF₄, for greatest efficiency—thereby avoiding the condensation and/or freezing of HF and CF₄ in the same separation unit. However, both HF and CF₄ can be separated from the purified F₂ gas product in the same separation unit.

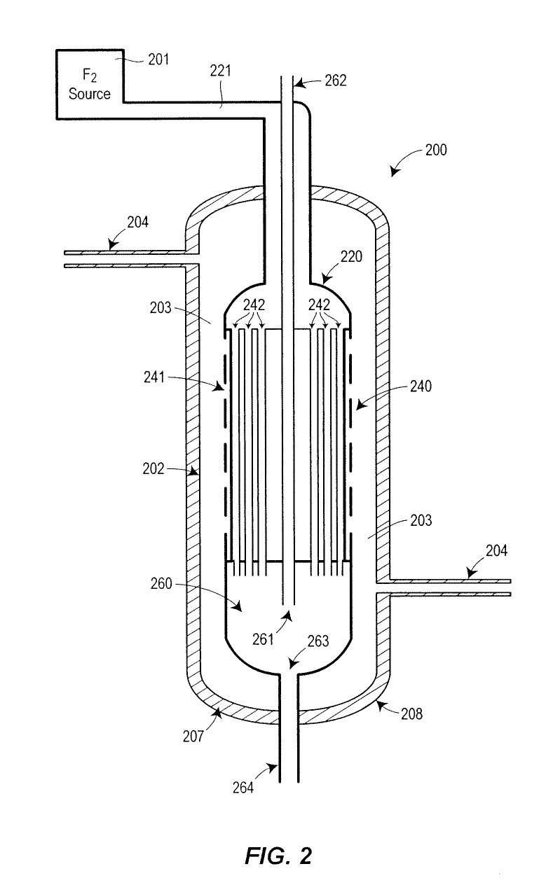

A first embodiment of the HF Separation Unit as shown in FIGS. 2, 3, and 4 is a Low Pressure HF Separation Unit. The Low Pressure HF Separation Units separate HF from the purified F₂ product stream by condensing liquid HF while maintaining F₂ as a gas. An added benefit of the Low Pressure HF Separation Units is that in the process of condensing HF, particulates of KF (KF dust) are dissolved in the HF liquid and thereby are removed from the F₂ product stream together with the liquid HF.

As shown in FIG. 2, one embodiment of the Low Pressure HF Separation Unit 200, has a HF Separation Chamber 220. The HF Separation Chamber 220 is located within a Coolant Chamber 202 filled with a Coolant 203. The Coolant 203 can be added and/or removed from the Coolant Chamber 202 by way of a Coolant Conduit 204. Often and preferably, the entire HF Separation Chamber 220 is in fluid communication with the Coolant 203. The Coolant 203 maintains the temperature of the HF Separation Chamber 220 at a temperature sufficiently low to condense HF gas to a liquid, preferably between −84° C. and 19.5° C., more preferably at a temperature between −84° C. and about −50° C., still more preferably at a temperature between −84° C. and about −70° C., even more preferably at a temperature between −84° C. and about −80° C., and most preferably at a temperature of about −82° C. Typically, but optionally, the Coolant Chamber 202 is surrounded by Insulation 207. The Insulation 207 can be a solid, liquid, gas, vacuum, or combination thereof that reduces incident heat transfer from the Coolant Chamber 202 to and from the external environment. Depending on the Insulation 207 employed, the Insulation 207 may be contained within an Insulation Chamber 208.

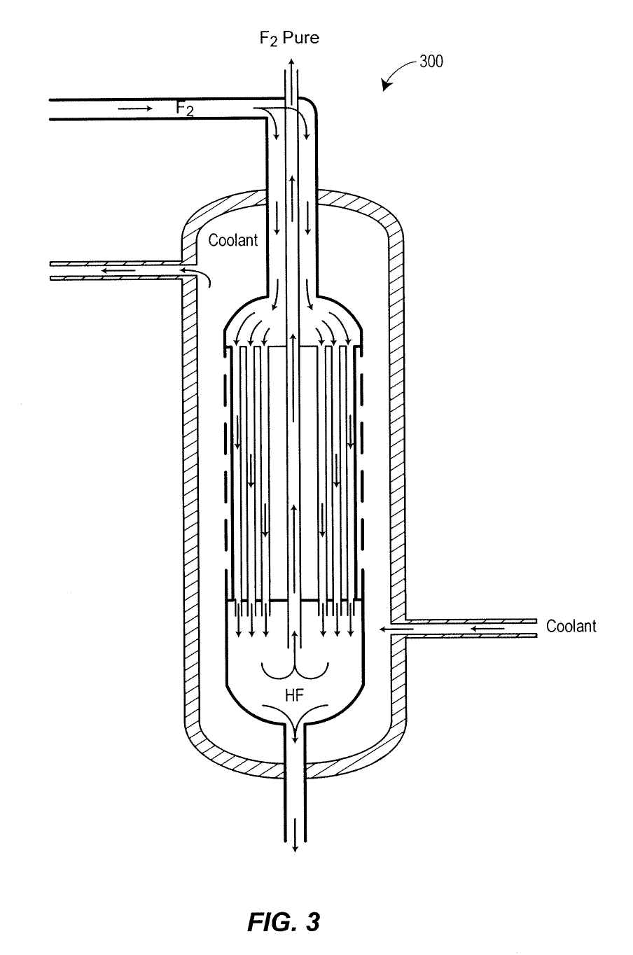

In the typical operation of the HF Separation Unit 200 shown in FIGS. 2 and 3, a F₂ Source 201 provides a F₂ product stream to the Separation Unit 200. The F₂ product can be obtained from an HF, KF, and/or CF₄-contaminated F₂ Source 201 that provides a F₂ product stream. Non-limiting examples include a electrolytic F₂ generator and a F₂ storage cylinder. The F₂ Source 201 is connected to the HF Separation Unit 200 by a F₂ Input Conduit 221. The F₂ product stream enters the separation unit through the F₂ Input Conduct 221 and flows into the HF Condensation Region 240.

The HF Condensation Region 240 (as used herein a Condensation Region is preferably the area within a unit where condensation occurs) is the area within the unit where HF preferably condenses and includes a Heat Exchanger 241 that is in fluid communication with the Coolant 203. Preferably, the entire Heat Exchanger 241 is in fluid communication with the Coolant 203. The Coolant 203 maintains the temperature of the Heat Exchanger 241, over which the product stream flows, at a temperature sufficiently low to condense gaseous HF to a liquid HF, preferably between −84° C. and 19.5° C., most preferably at a temperature between −84° C. and about −50° C., still more preferably at a temperature between −84° C. and about −70° C., even more preferably at a temperature between −84° C. and about −80° C., and most preferably at a temperature of about −82° C. The HF Condensation Region 240, in fluid communication with the coolant 203, preferably covers a majority of an internal surface area of the HF Separation Chamber 220 area, thereby maximizing the cooling of the product gas and facilitating the condensation of the gaseous HF into liquid HF. The Heat Exchanger 241 can be any design that effectuates the condensation of HF in the HF Condensation Region 240. Non-limiting examples of types of Heat Exchangers 241 include shell and tube heat exchangers, as shown, plate-type heat exchangers, spiral heat exchangers, ROD-baffle heat exchangers, and parallel counter flow heat exchangers. Preferably, the Heat Exchanger 241 is a shell and tube heat exchanger, as shown in FIGS. 2-4, having a plurality of flow Pathways 242 for product and/or coolant through the Heat Exchanger 241.

After partial or complete condensation of HF from the F₂ product stream in the HF Condensation Region 240, the F₂ product stream flows as a gas from the HF Condensation Region 240 to the F₂—HF Separation Region 260, as used herein a Separation Region is the region of a unit wherein the gaseous product and the liquid product are physically separated and diverted through different outlets. The F₂—HF Separation Region 260, preferably in fluid communication with the Coolant 203, includes an F₂ Outlet 261 and a HF Outlet 263. The F₂ Outlet 261 is positioned such that any condensed HF liquid cannot directly enter the F₂ Outlet 261. Preferably, the flow through the F₂ Outlet 261 is 180 from the flow through the HF Condensation Region 240. The purified F₂ product stream, wherein the concentrations of HF and KF were reduced, flows from the F₂—HF Separation Region 260, upwardly and depicted through the F₂ Outlet 261 and exits the HF Separation Unit 200 within the F₂ Outlet Conduit 262. The liquefied HF and any KF flows downwardly, via gravity, and exits the F₂—HF Separation Region 260 through the HF Outlet Opening 263, and exits the Low Pressure HF Separation Unit 200 through the HF Outlet Conduit 264.

FIG. 3 shows one embodiment of the flow of a F₂ product stream through a HF Separation Unit 300. The HF Separation Unit 300 continuously condenses HF and separates KF from a F₂ product stream. The F₂ product stream is purified by separating the liquid and/or solid KF and HF components from the F₂ gas.

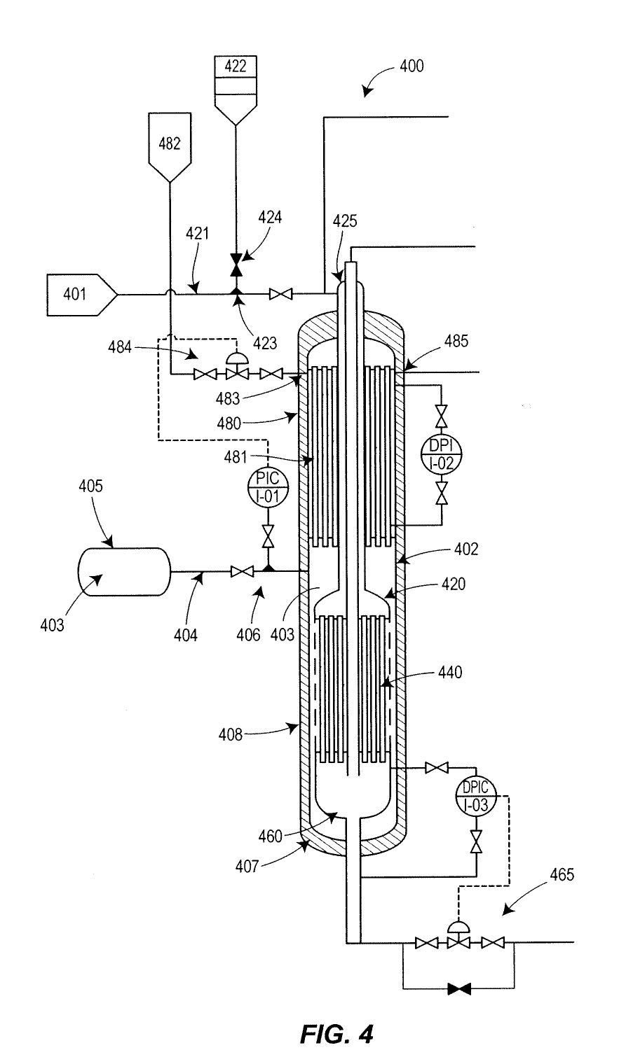

As shown in FIG. 4, another embodiment of the HF Separation Unit 400 has a HF Separation Chamber 420, wherein the HF is condensed and separated from the product stream, and an optional Coolant Condensation Unit 480. The HF Separation Chamber 420 and Coolant Condensation Unit 480 are located within a Coolant Chamber 402 that has a Coolant 403. The Coolant 403 can be added and/or removed from the Coolant Chamber 402 by way of a Coolant Conduit 404. The amount of coolant within the Coolant Chamber 402, preferably, covers or envelops the HF Separation Chamber 420. If and/or when necessary, additional Coolant 403 is added from a Coolant Storage Cylinder 405, with the addition and amount controlled by a Coolant Level Control Mechanism 406. Often and preferably, the entire HF Separation Chamber 420 is in fluid communication with the Coolant 403. The Coolant 403 maintains the temperature of the HF Separation Chamber 420 at a temperature sufficient to condense HF gas to a liquid, preferably between −84° C. and 19.5° C., more preferably at a temperature between −84° C. and about −50° C., still more preferably at a temperature between −84° C. and about −70° C., even more preferably at a temperature between −84° C. and about −80° C., and most preferably at a temperature of about −82° C. Typically, but optionally, the Coolant Chamber 402 is surrounded by Insulation 407. The Insulation 407 can be a solid, liquid, gas, vacuum, or combination thereof that reduces incident heat transfer from the Coolant Chamber 402 to and from the external environment. Depending on the Insulation 407 employed, the Insulation 407 may be contained within an Insulation Chamber 408.

In a typical operation of the HF Separation Unit 400 shown in FIG. 4, an F₂ Source 401, e.g., as described above for HF Separation Unit 200, provides a F₂ product stream to the separation unit. The F₂ Source 401 is connected to the HF Separation Unit 400 by a F₂ Input Conduit 421. Preferably, but optionally, the F₂ product stream is combined with a F₂ Carrier Gas 422 added to the F₂ Inlet Conduit 421 through a F₂ Carrier Gas Input valve 423. The addition, rate, and amount of F₂ Carrier Gas 422 is adjusted with an F₂ Carrier Gas Inlet Mechanism 424, optionally a valve, flow restrictor, solenoid, or the like, optionally, the F₂ Carrier Gas Input Valve 423 and the F₂ Carrier Gas Inlet Mechanism 424 are a single unit. The F₂ product stream enters the separation unit through an F₂ Inlet 425 and flows into the HF Condensation Region 440.

In addition to the description of the HF separation units described above, the embodiment of the HF Separation Unit 400 shown in FIG. 4 includes a means for controlling the level of liquid HF in the F₂—HF Separation Region 460. The level of liquid HF can be adjusted with an HF Outlet Control Mechanism 465, a valve, flow restriction devise, solenoid, of the like. The level of liquid HF in the F₂—HF Separation Region 460, is preferably low but can be increased to dissolve or rinse the F₂—HF Separation Region 460 of solid KF that may have carried over into the Low Pressure HF Separation Unit 400 from the F₂ Source 401.

An innovative feature of the embodiment shown in FIG. 4 is a means for controlling the temperature of the HF Separation Chamber 420 and recycling the Coolant 403. The ideal −82° C. temperature for the HF Separation Chamber 420 can be maintained when the Coolant 403 has a boiling point of about −82° C. Any preferred maximum temperature can be maintained through this use of boiling point temperature control. This boiling point control of the temperature of the HF Separation Chamber 420 can be maintained as long as the boiling liquid effectively envelops, e.g., completely surrounds, the HF Separation Chamber 420. The Coolant 403 can be any applicable refrigerant that has a boiling point at the desired control temperature. Non-limiting examples include CClF₃, CBrF₃, CF₄, CHClF₂, CHF₃, CH₂F₂, CH₃F, C₂F₆, C₁HF₅, 1,1,1-C₂H₃F₃, CH₄, C₂H₆, C₂F₄, C₂H₂F₂, and C₂H₄. Preferably, CHF₃ is used as the Coolant 403 in the F₂ purification processes described herein. CHF₃ has a boiling point of −82.1° C. Boiling CHF₃ can be refluxed via condensation and thereby recycled for further boiling when the Low Pressure HF Separation Unit 400 includes a Coolant Condensation Unit 480. The temperature dependant condensation of the Coolant 403 requires the temperature of the Coolant Condensation Unit 480 to be below that of the coolant boiling point. In the embodiment shown in FIG. 4, the Coolant Condensation Unit 480 is cooled by a Reflux Coolant 482, preferably N₂, at a temperature sufficient to condense gaseous coolant, e.g., CHF₃, to liquid coolant, preferably between about −196° C. and −83° C., more preferably at a temperature between about −196° C. and about −140° C., still more preferably between about −196° C. and about −176° C., and even more preferably at about −185° C. The Coolant Condensation Unit 480 has a Heat Exchanger 481, that effectuates the condensation of the Coolant 403. Non-limiting examples of Heat Exchanger 481 designs include shell and tube heat exchangers, plate-type heat exchangers, spiral heat exchangers, ROD-baffle heat exchangers, and parallel counter flow heat exchangers. Preferably, the Heat Exchanger 481 is a shell and tube heat exchanger, as shown in FIG. 4, having a large surface area for efficient heat exchange and condensation of Coolant 403. The temperature of the Heat Exchanger 481 is maintained by the addition of the Reflux Coolant 482 to the Heat Exchanger 481. The rate of addition of the Reflux Coolant 482 to the Heat Exchanger 481 is controlled by the Reflux Coolant Inlet Control Mechanism 484, a valve, solenoid, flow restrictor or the like that limits the rate and/or volume of the Reflux Coolant addition. Generally, the Reflux Coolant 482 flows through the Reflux Coolant Inlet 483, then the Heat Exchanger 481, and then exits through the Reflux Coolant Outlet 485.

Alternative embodiments of the Coolant Condensation Unit 480 can include other Reflux Coolants 482 and/or traditional refrigerant-based coolant cycles. To achieve the full advantage of the manufacturing and purification process described herein, the Reflux Coolant 482 should boil at a temperature sufficiently below the condensation point of the Coolant 403 to enable the reflux of the Coolant 403. In yet another embodiment, the Coolant Condensation Unit 480 can include a coolant compressor and heat ejector, wherein the heat of compression of the coolant is dissipated and the coolant is reloaded into the Coolant Chamber 402. Such an embodiment would function similarly to a traditional air conditioner or refrigeration system.

The operation of the HF Separation Chamber can be understood by reference to FIGS. 2 and 3 and the accompanying description, above. The Low Pressure HF Separation Unit can remove greater than 90% by weight of the HF in the F₂ product stream. Preferably, the Low Pressure HF Separation Unit removes greater than 95% by weight of the HF in the F₂ product stream, still more preferably the Low Pressure HF Separation Unit removes greater than 97% by weight of the HF in the F₂ product stream. Additionally, the Low Pressure HF Separation Unit removes greater than 99% by weight of KF from the F₂ product stream.

In another embodiment, the HF Separation Unit, e.g., those described above, can be operated at higher pressure. High Pressure HF separation units effectuate the removal of HF from the F₂ product stream by condensing HF from the product stream. Herein, the pressure of the product stream, preferably free of KF, is higher than atmospheric pressure (e.g., higher than one atmosphere), preferably twice atmospheric pressure (two atmospheres), more preferably greater than twice atmospheric pressure (greater than two atmospheres). By way of non-limiting example, the pressure can be raised by a F₂ compressor and/or by the addition of a high pressure inert gas (e.g., high pressure N₂). Generally, the pressure of the F₂ product feed out of the F₂ generator is atmospheric pressure or just slightly greater than atmospheric pressure—the pressure after pressurizing in a F₂ compressor is greater than atmospheric pressure. Generally, raising the pressure on a liquid (by compressing the liquid or increasing the pressure of the gas above the liquid) increases its boiling temperature. Correspondingly, raising the pressure of a gas facilitates the condensation of that gas. In one embodiment of the HF Separation Unit, the High Pressure HF Separation Unit operates in the same manner and with the same components as the Low Pressure HF Separation Unit, but at a higher pressure for easier condensation of HF.

The operation of the separation unit at above atmospheric pressure increases the percentage of HF removed from the F₂ product stream. Preferably, the High Pressure HF Separation Unit removes greater than 97% of the HF in the F₂ product stream, more preferably the High Pressure HF separation unit removes greater than 99% of the HF, still more preferably the High Pressure HF Separation Unit removes greater than 99.4% of the HF.

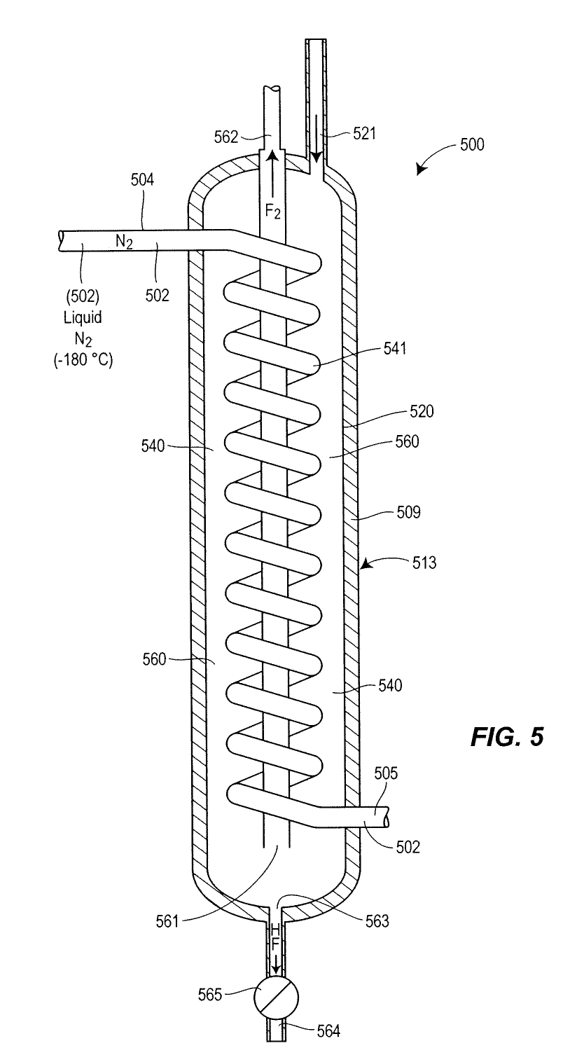

Another embodiment of the HF Separation Unit is a Low Temperature HF Separation Unit 500, as shown in FIG. 5. A Low Temperature HF Separation Unit 500 effectuates the separation of HF from the F₂ product stream by precipitating the HF from the product stream. Herein, precipitating refers to separating solid (frozen) HF from the F₂ product stream.

As shown in FIG. 5, one embodiment of the Low Temperature HF Separation Unit 500, has a HF Separation Chamber 520 where the HF Precipitation Region 540 and F₂—HF Separation Region 560 overlap. In this embodiment of the HF Separation Chamber 520, the Heat Exchanger or coolant chamber 541 is disposed within the HF Separation Chamber 520. The location of the Heat Exchanger 541 is dependent only on the efficiency of the heat exchange. The helical Heat Exchanger 541 of FIG. 5 effects efficient cooling of the F₂ product stream. Other designs of heat exchangers are applicable including shell and tube heat exchangers, plate-type heat exchangers, ROD-baffle heat exchangers, and parallel counter flow heat exchangers. The Coolant 502 enters the Heat Exchanger 541 from the Coolant Inlet Conduit 504 at a temperature sufficiently low to precipitate HF. Preferably, the Coolant 502 keeps the temperature within the HF Separation Chamber 520 between about −180° C. and −85° C., more preferably between −165° C. and −100° C., still more preferably between −150° C. and −130° C., and even more preferably between −145° C. and −135° C. The Coolant 502 exits the Heat Exchanger 541 and the HF Separation Chamber 520 through the Coolant Outlet Conduit 505.

Typically, but optionally, the HF Separation Chamber 520 and/or all parts with an internal or external temperature at or below about 0° C. are surrounded by Insulation 509. The Insulation 509 can be a solid, liquid, gas, vacuum, or combination thereof that reduces incident heat transfer from the HF Separation Chamber 520 to and from the external environment. Dependant on the Insulation 509 employed, the Insulation 509 may be contained within an Insulation Chamber 513.

In a typical operation of the Low Temperature HF Separation Chamber 500 shown in FIG. 5, a F₂ Source provides a F₂ product stream to the separation unit. Applicable herein is any F₂ Source that provides a F₂ product stream, as described above. The F₂ Source is connected to the Low Temperature HF Separation Unit 500 by a F₂ Input Conduit 521.

The low temperature, e.g., −145° C. to −135° C., provided by the Coolant 502 causes HF in the F₂ product stream to freeze and precipitate from the F₂ product stream within the HF Separation Chamber 520. The purified F₂ product stream, wherein the concentration of HF is reduced, flows from the HF Separation Unit 500 through the F₂ Outlet 561 and exits the Low Temperature HF Separation Unit 500 through the F₂ Outlet Conduit 562. The Low Temperature HF separation unit preferably reduces the amount of HF in the F₂ product stream to less than 5 ppm (v/v), more preferably to less than 1 ppm (v/v), and still more preferably to less than 0.5 ppm (v/v). The solid HF in the HF Separation Chamber 520 can impede the flow of the F₂ product stream through the HF Separation Chamber 520. The solid HF can be removed from the HF Separation Chamber by warming the HF Separation Chamber 520 to a temperature above the melting point of HF, for example by stopping the flow of Coolant 502 into the Heat Exchanger 541, and thereafter draining the HF Separation Chamber 520 of liquid and/or gaseous HF through the HF Outlet 563. The removal of non-solid HF from the HF Separation Chamber 520 is metered by the HF Outlet Control Mechanism 565, as described below. The HF Separation Unit 520 the HF Outlet Control Mechanism 565 (often a valve) generally restricts flow through the HF Outlet Conduit 564, thereby directing flow of the F₂ product stream through the HF Separation Unit 520 and out through the F₂ Outlet 561.

Additional control mechanisms can be provided (not shown) for the separation of HF from the F₂ product stream in the Low Temperature HF Separation Units described. The flow of the F₂ product stream from the F₂ source can be metered by an F₂ Inlet Control Mechanism that is in communication with a F₂ Flow Monitor. The F₂ Flow Monitor measures the flow of the F₂ product stream through the HF Separation Chamber. In one embodiment, the F₂ Flow Monitor is a differential pressure flow monitor, measuring the difference in pressure in the F₂ product stream before and after the HF Separation Chamber. Alternate F₂ Flow Monitors are applicable herein, for example Doppler flowmeters, ultrasonic flowmeters, vortex shedding flowmeters, vane piston flowmeters, variable area flowmeters, and the like. When the F₂ Flow Monitor registers a restriction in the flow through the HF Separation Chamber, the F₂ Inlet Control Mechanism decreases or stops the flow of F₂ product stream through the connected HF Separation Chamber. Additionally, when the F₂ Flow Monitor registers a restriction in the flow through the HF Separation Chamber and the F₂ Inlet Control Mechanism stops the flow of F₂ product stream, a Coolant Control Mechanism decreases or stops the flow of Coolant by metering the Coolant Inlet Regulator. The decrease in the flow of the Coolant into the Heat Exchanger causes the HF Separation Chamber to warm and the solid HF to melt. The opening of the HF Outlet Control Mechanism, e.g., a valve and/or solenoid, causes the liquid or gaseous HF to exit the HF Separation Chamber through the F₂ outlet.

Another embodiment of the Low Temperature HF Separation Unit has a plurality of HF Separation Chambers. The plurality of HF Separation Chambers are each connected to a F₂ Source and the F₂ product stream is metered by F₂ Inlet Control Mechanisms that are individually in fluid communication with F₂ Flow Monitors. The F₂ Flow Monitors measure the flow of F₂ product stream through the HF Separation Chambers. A Separation Unit By-Pass Mechanism in conjunction with the inlet control mechanisms restrict the flow through individual separation chambers when the flow monitors measure restrictions. The added benefit of a plurality of HF Separation Chambers is that the design permits continuous flow operation. Generally, the unit operates by restricting flow through one of the separation chambers by-passing that chamber and permitting flow through an alternate separation chambers. When one or more of the flow monitors measure a restriction, the Separation Unit By-Pass Mechanism in conjunction with the inlet control mechanisms switch the flow of the F₂ Product Stream to the unrestricted separation chamber. The restricted separation chamber is then warmed to melt the HF, the liquid HF is removed, and the unit readied to obtain the product stream when the working separation chamber becomes restricted. Depending on the amount of HF and the flow rates, greater than two separation chambers may be necessary.

Preferably, the Low Temperature HF Separation Unit described above continuously removes greater than 99% of the HF in the F₂ product stream, more preferably the remaining concentration of HF in the F₂ product steam is less than 100 ppm (v/v), still more preferably less than 10 ppm (v/v), ideally, less than 1 ppm (v/v).

Yet another embodiment of the HF separation unit is an Electrostatic HF separation unit. The Electrostatic HF separation unit effectuates the removal of HF from the F₂ product stream by precipitating the HF from the product stream and electrostatically collecting the solid HF fume from the F₂ product stream. In this embodiment, the F₂ product stream is cooled to less than −150° C., preferably between about −180° C. and −150° C., and more preferably to between −165° C. and −155° C., whereby any HF in the F₂ product stream precipitates. As the HF solid can be carried through the system by the flow of the F₂ product stream, the Electrostatic HF separation unit has in the F₂—HF separation region at least one electrostatic collection device, and preferably a plurality of electrostatic collection devices. The electrostatic collection device has a discharge electrode and a collection electrode, whereby the electrostatic potential created in the electrostatic collection device causes any solid HF fume to collect on the collection electrode. Similar to the Low Temperature HF Separation Unit, the flow through the electrostatic collection device can become restricted. A plurality of electrostatic collection devices allows switching between electrostatic collection devices and continuous operation of the HF separation unit. The Electrostatic HF Separation Unit reduces the amount of HF in the F₂ product stream to less than 1 ppm (v/v), preferably less than 0.5 ppm (v/v), more preferably less than 0.1 ppm (v/v).

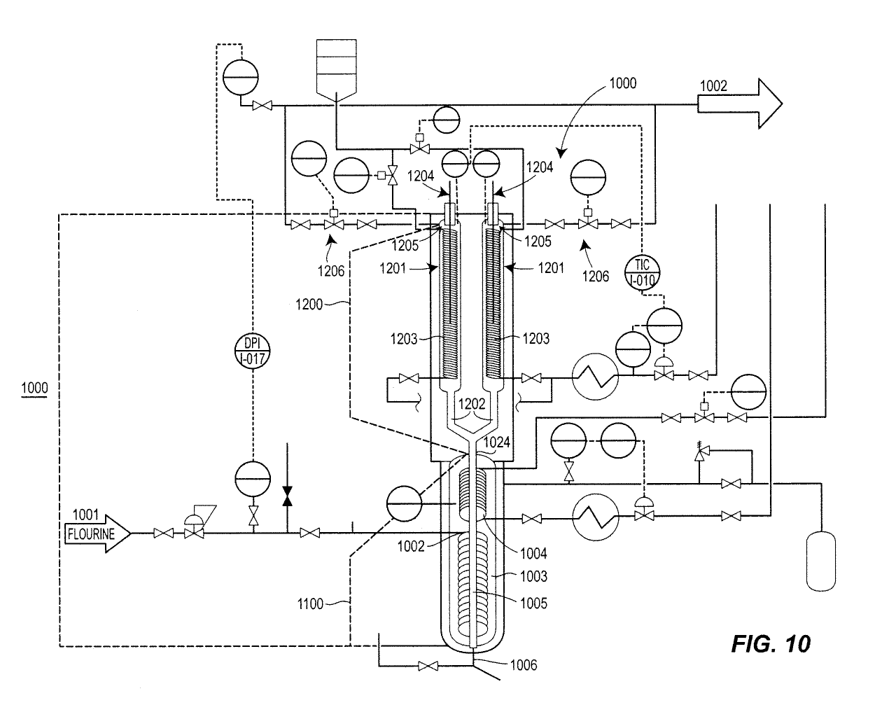

One embodiment of an Electrostatic HF Separation Unit, and the preferred embodiment of a HF Separation Unit, is shown in FIG. 10. The Electrostatic HF Separation Unit 1000 has two distinct HF Separation Regions, a liquid HF Separation Region 1100 and a solid, electrostatic, HF Separation Region 1200. The F₂ Product Stream 1001 first enters the liquid HF Separation Region 1100. The F₂ Product Stream 1001 in a F₂ Conduit 1002 is cooled within the HF Separation Region 1100 by the fluid communication of a Coolant 1003 with the F₂ Conduit 1002. Similar to the embodiment of the HF Separation Unit shown in FIG. 4 and disclosed above, the F₂ Conduit, and thereby the F₂ Product Stream is cooled by a recycled Coolant 1003. The Coolant 1003 maintains the temperature of the HF Separation Region 1100 at a temperature sufficient to condense HF gas to a liquid, preferably between −84° C. and 19.5° C., more preferably at a temperature between −84° C. and about −50° C., still more preferably at a temperature between −84° C. and about −70° C., even more preferably at a temperature between −84° C. and about −80° C., and most preferably at a temperature of about −82° C. The Coolant 1003 can be any applicable refrigerant that has a boiling point at the desired control temperature. Non-limiting examples include CClF₃, CBrF₃, CF₄, CHClF₂, CHF₃, CH₂F₂, CH₃F, C₂F₆, C₂HF₅, 1,1,1-C₂H₃F₃, CH₄, C₂H₆, C₂F₄, C₂H₂F₂, and C₂H₄. Preferably, CHF₃ is used as the Coolant 1003 in the F₂ purification processes described herein. The heat exchange of the Coolant 1003 with the F₂ Product Stream 1001, preferably, results in the boiling of the Coolant 1003. The Coolant 1003 is condensed, and thereby recycled, on a Coolant Condensation Unit 1004.

The F₂ Conduit 1002 is in fluid communication with a HF Separation Conduit 1005. The HF Separation Conduit 1005 diverts the condensed HF from the F₂ Product Stream. The HF liquid then exits the HF Separation Unit 1100 in a HF Outlet Conduit 1006. The F₂ Product Stream then enters a solid, electrostatic, HF Separation Region 1200.

The shown HF Separation Region 1200 has a Plurality of Electrostatic Collection Devices 1201 that provide for continuous operation of the unit. Each individual Electrostatic Collection Device 1201 has at least one Inlet 1202, Heat Exchanger 1203, Discharge Electrode 1204, Collection Electrode (not shown), and F₂ Outlet 1205. The F₂ Product Stream enters an Electrostatic Collection Device 1201 through an Inlet 1202, is cooled to a temperature sufficient to freeze HF and due to the electrostatic potential created within the device any solid HF fume collects on the Collection Electrode. The gaseous F₂ exits the HF Separation Region 1200 through the F₂ Outlet 1205. The separated HF solid is removed from the HF Separation Region 1200 by warming the chamber to a temperature above the melting point of HF and then draining the HF out of the HF Separation Region 1200 through the HF Outlet Conduit 1006. Switching or isolation of the Electrostatic Collection Devices 1200 is accomplished by F₂ Flow Controllers 1206. Also shown in FIG. 10 but not labeled for clarity are coolant temperature control units, additional flow units, collection units, and voltage controllers, all of which will be apparent to one of ordinary skill in the art.

### Removal of CF₄ from the F₂ Gas

A second embodiment of the purification of F₂ described herein is the removal of CF₄ from the F₂ product stream. In accordance with this embodiment, the removal of CF₄ is effectuated by a CF₄ Separation Unit operated in the same manner as described above for the removal of HF from F₂—operating by condensing CF₄ from the F₂ product stream. The CF₄ Separation Units, described herein, can continuously purify F₂ product stream via continuous CF₄ removal.

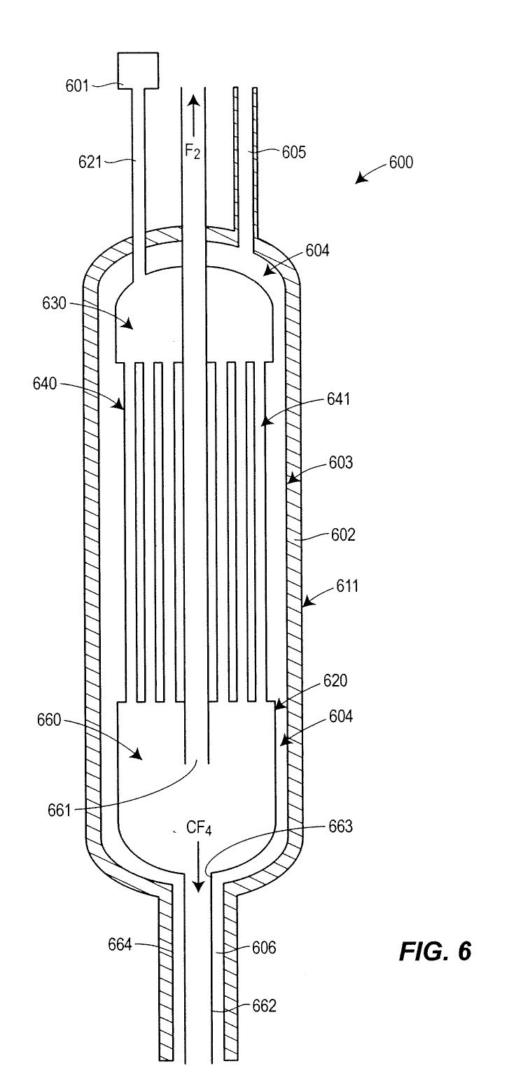

As shown in FIG. 6, a first embodiment of the CF₄ Separation Unit 600 has at least one CF₄ Separation Chamber 620, and optionally a plurality of CF₄ separation chambers. The CF₄ Separation Chamber 620 is located within a Coolant Chamber 603 filled with Coolant 604. Preferably the entire CF₄ Separation Chamber 620 is in fluid communication with the Coolant 604. The Coolant 604 is added via a Coolant Inlet Conduit 605. The Coolant 604 maintains a temperature of the CF₄ Separation Chamber 620, additionally, and preferably the Coolant 604 in the Coolant Outlet Conduit 664 maintains a temperature in the CF₄ Outlet Conduit 662. Preferably, the Coolant 604 maintains the temperature of the CF₄ Separation Chamber 620 and/or the CF₄ Outlet Conduit 662 at between about −196° C. and about −128° C., more preferably at a temperature between about −190° C. and about −160° C., still more preferably at a temperature between about −185° C. and about −180° C. A typical Coolant 604 is N₂ gas supplied from boiling liquid N₂ (N₂ boils at −196° C.).

Typically, but optionally, the Coolant Chamber 603 and/or all parts with an internal or external temperature at or below about 0° C. are surrounded by Insulation 602. The Insulation 602 can be a solid, liquid, gas, vacuum, or combination thereof that reduces incident heat transfer from the Coolant Chamber 603 to and from the external environment. Depending on the Insulation 602 employed, the Insulation 602 may be contained within an Insulation Chamber 611.

In a typical operation of the CF₄ Separation Unit 600 shown in FIG. 6, a F₂ Source 601, as described, provides a F₂ product stream to the separation unit 600. The F₂ Source 601 is connected to the CF₄ Separation Unit 600 by a F₂ Input Conduit 621. The F₂ product stream enters the separation unit 600 and flows into an CF₄ Condensation Region 630 & 640. Preferably, the F₂ product stream is pressurized to a pressure in the range of above atmospheric to about 10 atmospheres and precooled to a temperature in the range of about −120° C. to about −160° C. prior to entering the CF₄ Separation Chamber 620.

Following the first CF₄ Condensation Region 630, the F₂ product stream enters a second CF₄ Condensation Region 640. The CF₄ Condensation Region 640 has a Heat Exchanger 641 that is in fluid communication with the Coolant 604. Preferably, the entire Heat Exchanger 641 is in communication with the Coolant 604, that maintains the temperature of the Heat Exchanger 641 at a temperature sufficient to condense the CF₄ to a liquid, preferably between about −190° C. and −128° C., more preferably at a temperature between about −190° C. and about −160° C., still more preferably at a temperature between about −190° C. and about −180° C., even more preferably at a temperature of about −185° C. The Heat Exchanger 641 is any design that effectuates the condensation of CF₄ in the CF₄ Condensation Region 640. Preferably, the CF₄ Separation Chamber 620 has an internal surface area in fluid communication with the F₂ product stream where the greatest percentage of the internal surface area is in the CF₄ Condensation Region 640. Non-limiting examples of Heat Exchanger 641 designs include shell and tube exchangers, plate-type exchangers, spiral heat exchangers, ROD-baffle exchanges, and parallel counter flow exchangers. Preferably, the Heat Exchanger 641 is a shell and tube heat exchanger, as shown in FIG. 6, having a plurality of Pathways through the Heat Exchanger 641.

After condensation of CF₄ from the F₂ product stream in the CF₄ Condensation Region 640, the F₂ product stream transitions to the F₂—CF₄ Separation Region 660. The F₂—CF₄ Separation Region 660, preferably in communication with the Coolant 604, includes a F₂ Outlet 661 and a CF₄ Outlet 663. The F₂ Outlet 661 is positioned such that any condensed CF₄ liquid cannot directly enter the F₂ Outlet 661. Preferably, the flow through the F₂ Outlet 661 is 180° from the flow through the CF₄ Condensation Region 640. The purified F₂ product stream, wherein the concentration of CF₄ was reduced, flows from the F₂—CF₄ Separation Region 660 through the F₂ Outlet 661 and exits the CF₄ Separation Unit 600. The liquefied CF₄ exits the F₂—CF₄ Separation Region 660 through the CF₄ Outlet 663, that is positioned to remove liquid CF₄ from the CF₄ Separation Chamber 620, and exits the CF₄ Separation Unit 600 within the CF₄ Outlet Conduit 662.

The CF₄ Separation Unit 600 preferably reduces the amount of CF₄ in the F₂ product stream to less than 100 ppm (v/v), preferably less than 50 ppm (v/v), more preferably less than 20 ppm (v/v), and still more preferably to less than 10 ppm (v/v).

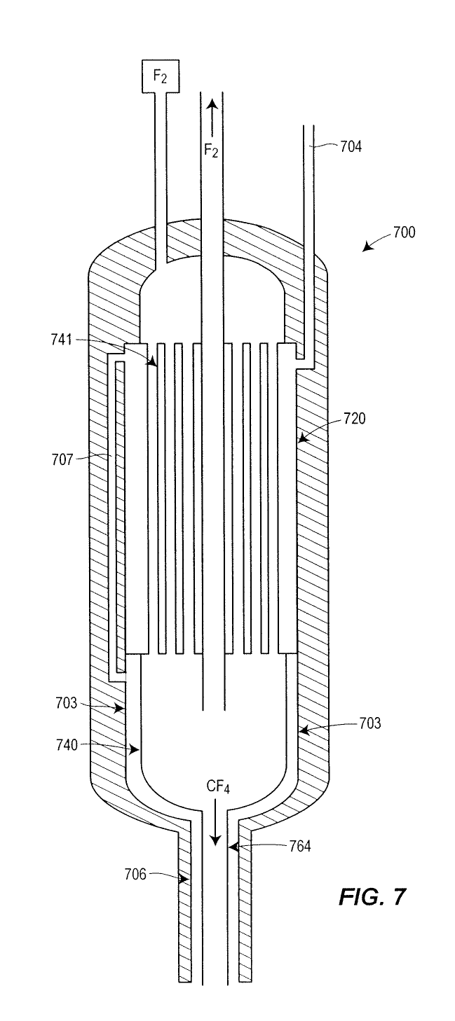

As shown in FIG. 7, a second embodiment of the CF₄ Separation Unit 700 differs from the CF₄ Separation Unit 600 depicted in FIG. 6 primarily by the design of the coolant system. Particularly, the CF₄ Separation Chamber 720 is not located entirely within the Coolant Chamber 703. In this embodiment of the CF₄ Separation Unit 700, the Coolant 704 enters the Heat Exchanger 741 of the CF₄ condensation region through a Coolant Inlet Conduit 705. The Coolant 704 maintains a temperature within the CF₄ condensation region, then the Coolant 704 exits the Heat Exchanger 741 and flows to the Coolant Chamber 703 through a Coolant Transfer Conduit 707. The Coolant Chamber 703 surrounds all of the external area of the CF₄ Separation Chamber 740. The Coolant 704 departs the CF₄ Separation Unit 700 in a Coolant Outlet Conduit 706 that is, optionally, positioned to maintain a temperature in at least a portion of the CF₄ Outlet Conduit 764. Preferably, the Coolant Outlet Conduit 706 surrounds at least a portion of the CF₄ Outlet Conduit 764. This embodiment prevents early condensation of CF₄, requires less material, and reduces the amount of coolant necessary to maintain the coolant temperature.

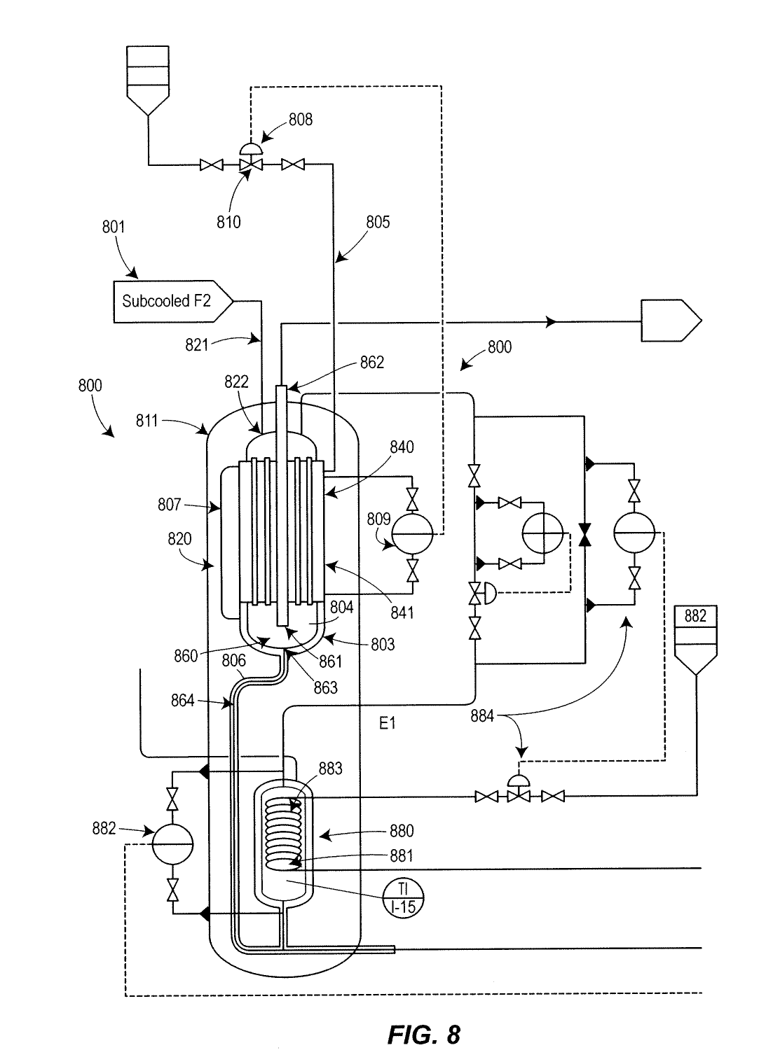

As shown in FIG. 8, another embodiment of the CF₄ Separation Unit 800 has at least one CF₄ Separation Chamber 820, and, optionally, a F₂-Reboiler 880. The coolant system for the CF₄ Separation Chamber 820 is similar to the system shown in FIG. 7, and the method of operation and design can be understood with reference to FIGS. 6 and 7 as well as their operations, described above. Specific to FIG. 8, and omitted from earlier figures for clarity, is a Coolant Control Mechanism 808. The Coolant Control Mechanism 808 (a valve, solenoid, flow restrictor, or the like) effectuates a Coolant Inlet Regulator 810 when a Temperature Monitor 809 designates the need for additional Coolant. Similar to FIG. 7 the Coolant maintains a temperature in the CF₄ Separation Region 804, and preferably the Coolant in the Coolant Outlet Conduit 806 maintains a temperature in the CF₄ Outlet Conduit 864.

Additionally, the Coolant maintains a temperature in the F²-Reboiler 880. Preferably, the Coolant maintains the temperature of the CF₄ Separation Region 804 and/or the CF₄ Outlet Conduit 864 and/or the F₂-Reboiler 880 at a temperature sufficient to permit evaporation of F₂ and sufficient to condense CF₄. The temperature is preferably between about −190° C. and about −128° C., more preferably at a temperature between about −190° C. and about −160° C., still more preferably at a temperature between about −185° C. and about −180° C. A typical Coolant is N₂ gas supplied from boiling liquid N₂ (N₂ boils at −196° C.).

Typically, but optionally, the CF₄ Separation Chamber 820, the F₂-Reboiler 880 the Coolant Transfer Conduit 807, the CF₄ Outlet Conduit 864 and/or all parts with an internal or external temperature at or below about 0° C. are surrounded by insulation. The insulation can be a solid, liquid, gas, vacuum, or combination thereof that reduces incident heat transfer from the Coolant Chamber 803 to and from the external environment. Dependant on the insulation employed, the Insulation may be contained within an Insulation Chamber 811.

In the typical operation of the CF₄ Separation Unit 800 shown in FIG. 8, a F₂ Source 801, as described, provides a F₂ product stream to the separation unit 800. Preferably the F₂ Source 801 provides the F₂ product stream with less than about 10 ppm (v/v) of HF, more preferably the F₂ Source 801 is a Low Temperature HF Separation Unit or an Electrostatic HF Separation Unit. The F₂ Source 801 is connected to the CF₄ Separation Unit 800 by an F₂ Inlet Conduit 821. The F₂ product stream enters the separation unit through the F₂ Inlet Opening 822 and flows into a CF₄ Condensation Region 840.

The CF₄ Condensation Region 840 has a Heat Exchanger 841 that is in communication with the Coolant. Often and preferably, the entire Heat Exchanger 841 is in communication with the Coolant that maintains the temperature of the Heat Exchanger 841 at a temperature sufficient to condense CF₄, preferably between about −190° C. and −128° C., more preferably at a temperature between about −190° C. and about −160° C., still more preferably at a temperature between about −190° C. and about −180° C., even more preferably at a temperature of about −185° C. The CF₄ Condensation Region 840, in communication with the coolant, preferably has the majority of the internal CF₄ Separation Chamber 820 surface area, thereby maximizing the cooling of the product gas and facilitating the condensation of the CF₄ liquid. The Heat Exchanger 841 is any design that effectuates the condensation of CF₄ in the CF₄ Condensation Region 840. Non-limiting examples of Heat Exchanger 841 designs include shell and tube exchangers, plate-type exchangers, spiral heat exchangers, ROD-baffle exchanges, and parallel counter flow exchangers. Preferably, the Heat Exchanger 841 is a shell and tube heat exchanger, having a plurality of pathways through the Heat Exchanger 841.

After condensation of CF₄ from the F₂ product stream in the CF₄ Condensation Region 840, the F₂ product stream transitions to the F₂—CF₄ Separation Region 860. The F₂—CF₄ Separation Region 860, preferably in communication with the Coolant, includes a F₂ Outlet 861 and a CF₄ Outlet 863. The F₂ Outlet 861 is positioned such that any condensed CF₄ liquid cannot directly enter the F₂ Outlet 861. Preferably, the flow through the F₂ Outlet 861 is 180° from the flow through the CF₄ Condensation Region 840. The purified F₂ product stream, wherein the concentration of CF₄ was reduced, flows from the F₂—CF₄ Separation Region 860 through the F₂ Outlet 861 and exits the CF₄ Separation Unit 800 within the F₂ Outlet Conduit 862. The liquefied CF₄, often including a large amount of liquid F₂, exits the F₂—CF₄ Separation Region 860 through the CF₄ Outlet 863, that is positioned to remove liquid CF₄ from the CF₄ Separation Chamber 820, and exits the CF₄ Separation Unit 800 within the CF₄ Outlet Conduit 864.

The condensed CF₄ in the CF₄ Outlet Conduit 864 can, optionally, enter the F₂ Reboiler 880. Preferably, the CF₄ Separation Chamber 820 and the F₂ Reboiler 880 are positioned in a vertical alignment, so the CF₄ Outlet Conduit 864 acts as a seal leg between the two chambers. This preferably arrangement permits the F₂ Reboiler 880 to operate at a higher pressure than the CF₄ Separation Chamber 820. The F₂ Reboiler 880 has a Reboiler Chamber 881, optionally surrounded by the Coolant Chamber 803 or the Coolant Outlet Conduit 806. Additionally, the F₂ Reboiler 880 has a Reboiler Control Mechanism 882, a Reboiler Heat Exchanger 883, and a Reboiler Temperature Control Mechanism 884. The Reboiler Control Mechanism 882 controls the flow of gaseous F₂ (a F₂ product stream) out of the F₂ Reboiler 880. The selective distillation of F₂ gas from CF₄ liquid is controlled by the Reboiler Temperature Control Mechanism 884 and the selective addition of a liquid or gas to the Reboiler Heat Exchanger 883. Typically, the F₂ Reboiler partially flashes the mixture of liquid F₂ and CF₄, the gaseous product often contains a quantity of CF₄ and is recycled to the a CF₄ Separation Chamber 820. In FIG. 8, the recycling of the gaseous product to the CF₄ Separation Chamber 820 is controlled by the Reboiler Control Mechanism 882, optionally, the Reboiler Control Mechanism 882 can cycle the distillation product to a secondary CF₄ Separation Chamber.

Generally, the separation of CF₄ from the F₂ product stream involves the condensation of both F₂ and CF₄. The recovery of the F₂ from the separated CF₄ is desirable because the recovery reduces the expense of generating F₂ and reduces the expenses and hazards of disposing of CF₄ contaminated with F₂. Preferably, the liquid F₂—CF₄ mixture is heated by “warm” N₂ gas. The warming of the liquid mixture will facilitate the evaporation of dissolved F₂, the evaporated gas will additionally contain a small amount of CF₄. The F₂-reboiler preferably reduces the F₂ concentration in the CF₄ waste stream to less than 15% of the F₂ concentration in the CF₄ waste exiting the F₂—CF₄ separation region.

The CF₄ Separation Unit 800 preferably reduces the amount of CF₄ in the F₂ product stream to less than 100 ppm (v/v), preferably less than 50 ppm (v/v), more preferably less than 20 ppm (v/v), and still more preferably to less than 10 ppm (v/v).

### Removal of KF, HF, and CF₄ from the F₂ Gas

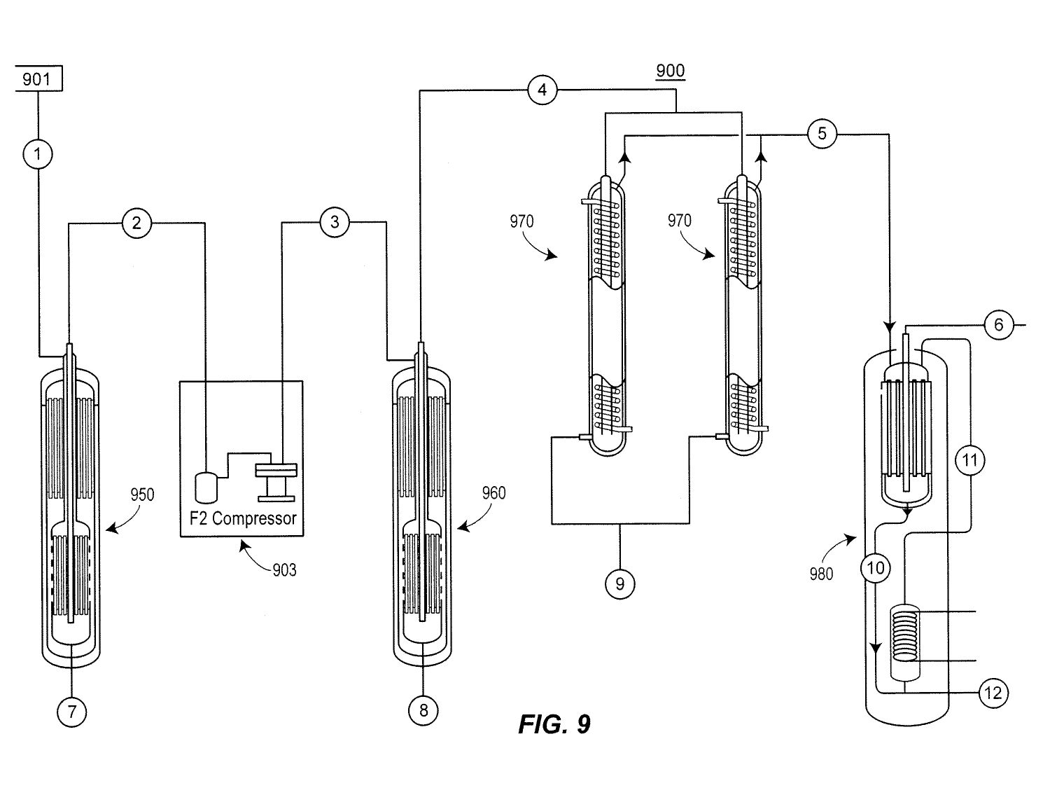

As shown in FIG. 9, one embodiment of the methods and apparati described herein is a Fluorine Purification Apparatus, generally referred to by reference numeral 900. The Fluorine Purification Apparatus 900 shown in FIG. 9 has three HF Separation Units (a Low Pressure HF Separation Unit 950, a High Pressure HF Separation Unit 960, and a Low Temperature HF Separation Unit 970) and a CF₄ Separation Unit 980. In normal operation of the Fluorine Purification Apparatus 900, fluorine from a Fluorine Generator 901 (a F₂ product stream) flows into the apparatus 900 by way of a F₂ Stream Conduit 1. The HF concentration in the F₂ product stream is first decreased, preferably to 4,000 ppm (v/v) or below, by a Low Pressure HF Separation Unit 950; the Low Pressure HF Separation Unit 950 additionally removes KF dust from the F₁ product stream. The F₂ product stream then flows through the F₂ Stream Conduit 2 to a F₂ Compressor 903 where the pressure of the F₂ product stream is increased. The pressurized F₂ product stream then flows through the F₂ Stream Conduit 3 to a High Pressure HF Separation Unit 960. The HF concentration in the F₂ product stream is decreased, preferably to 1,000 ppm (v/v) or below, by the High Pressure HF Separation Unit 960. The pressurized F₂ product stream then flows through the F₂ Stream Conduit 4 to a plurality Low Temperature HF Separation Unit 970. The HF concentration in the F₂ product stream is then decreased, preferably to 10 ppm (v/v) or below, by the Low Temperature HF Separation Unit 970. The F₂ product stream then flows through the F₂ Stream Conduit 5 to a CF₄ Separation Unit 980. The CF₄ concentration in the F₂ product stream is then decreased, preferably to 20 ppm (v/v) or below, by the CF₄ Separation Unit 980. The F₂ product stream then flows through the F₂ Stream Conduit 6 and exits the Fluorine Purification Apparatus 900, optionally to a NF₃ generator.

### Example

The following example further illustrates the methods and apparati of the present invention. Those skilled in the art will recognize that modification to the apparati and methods are available and may be different from those represented in the example.

A Fluorine Purification Apparatus 900 similar to that shown in FIG. 9 was constructed and tested. In the direction of F₂ flow from the F₂ Generator 901 the apparatus in FIG. 9 has a Low Pressure HF Separation Unit 950, a F₂ Compressor 903, a High Pressure HF Separation Unit 960, a plurality or Low Temperature HF Separation Units 970 and a CF₄ Separation Unit 980. Reference to the operation of these individual units, the mode and operation of the coolants within these units, and other specifics can be found above in the description of the similarly labeled units and in FIGS. 2-8.

In this example, the liquid coolants in the Low Pressure HF Separation Unit 950 and the High Pressure HF Separation Unit 960 were CHF₃, which maintained an approximate −82° C. in the respective condensation and separation regions. The reflux coolant in the Low Pressure HF Separation Unit 950 and the High Pressure HF Separation Unit 960 was cryogenic nitrogen, entering the units at approximately −185° C. The flow rate of the nitrogen into the Low Pressure HF Separation Unit 950 was approximately 270 kg/h; the flow rate of the nitrogen into the High Pressure HF Separation Unit 960 was approximately 90 kg/h. The coolant in both Low Temperature HF Separation Units 970 was cryogenic nitrogen, cycled from the other separation units (see for example FIG. 1), entered the units at approximately −180° C. with a flow rate of approximately 430 kg/h. The coolant in the CF₄ Separation Unit 980 was cryogenic nitrogen entering the unit at approximately −185° C. with a flow rate of approximately 75 kg/h.

Flow rates, temperatures, and compositions of samples were taken from the apparatus at various points along the purification pathway. These points are labeled 1-12 in FIG. 9. The results for these measurements are listed in Table 1.

TABLE 1

| Stream | | | Pressure | | | | | |
|---|---|---|---|---|---|---|---|---|
| No. | Stream Name | ° C. | (atm) | Flowrate | F₂ | CF₄ | HF | Total |
| 1 | Crude F₂ | 25 | 1.00 | kmol/h | 5.3198 | 0.0037 | 0.8665 | 6.1901 |
| | | | | kg/h | 202.14 | 0.33 | 17.34 | 219.80 |
| 2 | LP F₂ | −82 | 1.00 | kmol/h | 5.3168 | 0.0037 | 0.0199 | 5.3404 |
| | | | | kg/h | 202.02 | 0.33 | 0.40 | 202.75 |
| 3 | HP F₂ | 14.8 | 3.90 | kmol/h | 5.3168 | 0.0037 | 0.0199 | 5.3404 |
| | | | | kg/h | 202.02 | 0.33 | 0.40 | 202.75 |
| 4 | HP F₂-Low HF | −82 | 3.90 | kmol/h | 5.3166 | 0.0037 | 0.005 | 5.3253 |
| | | | | kg/h | 202.01 | 0.33 | 0.10 | 202.44 |
| 5 | LT F₂ | −140 | 3.80 | kmol/h | 5.3159 | 0.0036 | 0 | 5.3195 |
| | | | | kg/h | 201.99 | 0.32 | 0.00 | 202.30 |
| 6 | Purified F₂ | −175 | 3.61 | kmol/h | 5.1894 | 0 | 0 | 5.1894 |
| | | | | kg/h | 197.18 | 0.00 | 0.00 | 197.18 |
| 7 | Separated HF | −84 | 1.00 | kmol/h | 0.003 | 0 | 0.8466 | 0.8496 |
| | | | | kg/h | 0.11 | 0.00 | 16.94 | 17.05 |
| 8 | Separated HF | −82 | 3.90 | kmol/h | 0.0002 | 0 | 0.0149 | 0.0151 |
| | | | | kg/h | 0.01 | 0.00 | 0.30 | 0.31 |
| 9 | Separated HF | −140 | 3.80 | kmol/h | 0.0007 | 0 | 0.005 | 0.0058 |
| | | | | kg/h | 0.03 | 0.00 | 0.10 | 0.13 |
| 10 | F₂—CF₄ Liq | −175 | 3.61 | kmol/h | 1.2937 | 0.0037 | 0 | 1.2974 |
| | | | | kg/h | 49.16 | 0.33 | 0.00 | 49.48 |
| 11 | Recycled F₂ | −174 | 3.62 | kmol/h | 1.1676 | 0.0001 | 0 | 1.1676 |
| | | | | kg/h | 44.37 | 0.01 | 0.00 | 44.37 |
| 12 | Separated CF₄ | −174 | 3.81 | kmol/h | 0.1261 | 0.0036 | 0 | 0.1297 |
| | | | | kg/h | 4.79 | 0.32 | 0.00 | 5.11 |

1. A continuous method of separating HF from a gas mixture having F₂ gas and HF gas to form a purified F₂ gas, comprising:
flowing the gas mixture into a HF separation chamber that is cooled to a temperature sufficient to convert HF gas to HF liquid;
maintaining the temperature of the HF separation chamber at about −84° C. to about −80° C. by boiling a liquid refrigerant in fluid communication with the HF separation chamber:
converting HF gas to HF liquid in the HF separation chamber;
flowing the purified F₂ gas out of the HF separation chamber; and at the same time
removing HF liquid from the HF separation chamber.

2. The method of claim 1 further comprising a continuous flow of the gas mixture into the separation chamber.

3. (canceled)

4. (canceled)

5. The method of claim 1, wherein the coolant comprises CHF₃.

6. The method of claim 1 further comprising recycling the refrigerant for heat exchange with the gas mixture in the HF separation chamber by condensing the refrigerant and returning the condensed refrigerant to the liquid refrigerant in fluid communication with the HF separation chamber; wherein the liquid refrigerant is heated by the heat exchange with the gas mixture to a degree sufficient to vaporize the liquid refrigerant coolant.

7. The method of claim 6, wherein the refrigerant is condensed by contacting the vaporized refrigerant with a heat exchanger in fluid communication with a reflux coolant; and maintaining the reflux coolant at a temperature below the boiling point of the refrigerant.

8. The method of claim 1, wherein the purified F₂ gas comprises less than 4000 ppm (v/v) HF.

9. The method of claim 8, wherein the purified F₂ gas comprises less than 1000 ppm (v/v) HF.

10. The method of claim 1 further comprising maintaining the gas mixture within the HF separation chamber is at a pressure above about one atmosphere.

11. The method of claim 10, wherein the gas mixture is maintained is at a pressure of at least two atmospheres.

12. The method of claim 1 further comprising
flowing the purified F₂ gas from the first HF separation chamber cooled to a temperature sufficient to convert HF gas to HF liquid into a second separation chamber that is cooled to a temperature sufficient to convert HF gas to HF solid; and
flowing the purified F₂ gas out of the second HF separation chamber thereby separating the HF solid from the gas mixture.

13. The method of claim 12, wherein the temperature sufficient to convert HF gas to HF solid is between about −180° C. and about −85° C.

14. The method of claim 12, wherein the purified F₂ gas comprises less than 5 ppm (v/v) HF.

15. The method of claim 14, wherein the purified F₂ gas comprises less than 1 ppm (v/v) HF.

16. The method of claim 12, wherein the HF solid is separated from the gas mixture electrostatically.

17. The method of claim 16, wherein the purified F₂ gas comprises less than about 0.5 ppm (v/v) HF.

18. The method of claim 17, wherein the purified F₂ gas comprises less than about 0.1 ppm (v/v) HF.

19. (canceled)

20. A method of purifying a gas mixture, comprising a F₂ gas and a HF gas, to form a purified F₂ gas comprising:
establishing a continuous flow of the gas mixture;
flowing the F₂ gas mixture into a first HF separation chamber that is cooled to a temperature sufficient to convert the HF gas to a HF solid;
separating the HF solid from the gas mixture in the first HF separation chamber;
diverting the flow of the gas mixture from the first HF separation chamber to a second HF separation chamber that is cooled to a temperature sufficient to convert the HF gas to a HF solid;
separating the HF solid from the gas mixture in the second HF separation chamber and concurrently warming the first HF separation chamber to a temperature sufficient to melt the HF solid and form a HF liquid; and
removing the HF liquid from the first HF separation chamber.

21. The method of claim 20, wherein after the formation of solid HF in the second HF separation chamber, melting the HF solid from the first HF separation chamber, and removing the melted HF solid from the first HF separation chamber, the first HF separation chamber is cooled to a temperature sufficient to convert the HF gas to a HF solid and the flow of the gas mixture is diverted back to the first HF separation chamber; and thereafter HF liquid is removed from the second HF separation chamber.

22. A method of separating CF₄ from a gas mixture comprising F₂ gas and CF₄ gas and less than 10 ppm (v/v) HF gas to form a purified F₂ gas, comprising:
flowing the gas mixture into a CF₄ Separation Chamber that is cooled to a temperature sufficient to convert CF₄ gas to CF₄ liquid;
converting the CF₄ gas to CF₄ liquid;
flowing the purified F₂ gas out of the CF₄ Separation Chamber; and at the same time
removing CF₄ liquid from the CF₄ Separation Chamber.

23. The method of claim 22, wherein the CF₄ liquid comprises CF₄ and F₂; further comprising distilling F₂ gas from the CF₄ liquid and flowing the distilled F₂ gas into the CF₄ Separation Chamber.

24. The method of claim 23, wherein the CF₄ separation chamber is maintained at a temperature in the range of about −196° C. and about −128° C.

25. The method of claim 22, wherein the purified F₂ gas comprises less than 50 ppm (v/v) CF₄.

26. The method of claim 25, wherein the purified F₂ gas comprises less than about 20 ppm (v/v) CF₄.

27. The method of claim 26, wherein the purified F₂ gas comprises less than about 10 ppm (v/v) CF₄.

28. A method of purifying a gas mixture, comprising a F₂ gas, a HF gas, and a CF₄ gas, to form a purified F₂ gas comprising:
flowing the gas mixture into a HF separation chamber that is cooled to a temperature sufficient to convert the HF gas to a HF liquid;
maintaining the temperature of the HF separation chamber at about −84° C. to about −80° C. by boiling a liquid refrigerant in fluid communication with the HF separation chamber;
reducing a HF concentration in the gas mixture to less than about 10 ppm (v/v) HF; and then
flowing the gas mixture into a CF₄ separation chamber that is cooled to a temperature sufficient to convert the CF₄ gas to a CF₄ liquid;
reducing a CF₄ concentration in the gas mixture to less than about 100 ppm (v/v) CF₄; and
removing the purified F₂ gas from the CF₄ separation chamber.

29. A method of manufacturing NF₃ comprising
reacting a NH₃ gas with a purified F₂ gas, wherein the purified F₂ gas is obtained by the method of claim 1.

30. The method of claim 29, wherein the purified F₂ gas contains less than 10 ppm (v/v) CF₄; and the purified F₂ gas is obtained from a gas mixture comprising a F₂ gas, a HF gas, and a CF₄ gas by:
flowing the gas mixture into a HF separation chamber that is cooled to a temperature sufficiently low to convert the HF gas to a HF liquid;
separating the HF liquid from the gas mixture;
flowing the remaining gas mixture into a CF₄ separation chamber that is cooled to a temperature sufficiently low to convert the CF₄ gas to a CF₄ liquid;
separating the CF₄ liquid from the remaining gas mixture to form the purified F₂ gas; and
removing purified F₂ gas from the CF₄ separation chamber.

31. A method of manufacturing NF₃ comprising reacting a NH₃ gas with a purified F₂ gas, wherein the purified F₂ gas is obtained by the method of claim 20.

32. A method of manufacturing NF₃ comprising
reacting a NH₃ gas with a purified F₂ gas, wherein the purified F₂ gas is obtained by the method of claim 22.

33. A method of manufacturing NF₃ comprising reacting a NH₃ gas with a purified F₂ gas, wherein the purified F₂ gas is obtained by the method of claim 28.

34. The method of claim 28 further comprising recycling the refrigerant for heat exchange with the gas mixture in the HF separation chamber by condensing the refrigerant and returning the refrigerant to the liquid refrigerant in fluid communication with the HF separation chamber; wherein the refrigerant is heated by the heat exchange with the gas mixture to a degree sufficient to vaporize the refrigerant.

35. The method of claim 28, wherein the CF₄ liquid comprises CF₄ and F₂; further comprising distilling F₂ gas from the CF₄ liquid and flowing the distilled F₂ gas into the CF₄ Separation Chamber.
